(19) United States
(12) Patent Application Publication
(10) Pub. No.: US 2020/0345575 A1
(43) Pub. Date: Nov. 5, 2020

(54) HAND EXOSKELETON DEVICE

(71) Applicant: ECOLE POLYTECHNIQUE FEDERALE DE LAUSANNE (EPFL), Lausanne (CH)

(72) Inventors: Luca RANDAZZO, Lausanne (CH); José DEL R. MILLÁN, Lonay (CH)

(21) Appl. No.: 16/760,610

(22) PCT Filed: Nov. 1, 2018
(86) PCT No.: PCT/IB2018/058580

§ 371 Date: Apr. 30, 2020

(30) Foreign Application Priority Data
Nov. 7, 2017 (IB) PCT/IB2017/056954

(51) Int. Cl. A61H 1/02

(52) U.S. Cl. CPC A61H 1/0288; A61H 2201/0107; A61H 2201/1652; A61H 2201/14; A61H 2201/1638; A61H 2201/123

(57) ABSTRACT

The invention relates to a hand exoskeleton device having a modular nature. The device is designed to be wearable, portable and light in weight, and comprises from one to ten modules each having an actuating mechanism such as a linear actuator coupled with an artificial tendon having a flexible cable or shaft encased into a sheath and an elastic, stretchable portion on its distal end. The exoskeleton allows controlling flexion-extension of the fingers, while keeping natural somatosensorial interactions with the environment surrounding the users. The device is useful to e.g. assist and restore hand functions of users with motor disabilities both during activities of daily living and in neurorehabilitative scenarios, as well in other scenarios such as virtual reality.

### CORRESPONDING APPLICATION

The present application claims priority to the earlier application No PCT/162017/056954 filed on Nov. 7, 2017 in the name of ECOLE POLYTECHNIQUE FEDERALE DE LAUSANNE (EPFL), the content of this early application being incorporated by reference in the present application.

### TECHNICAL FIELD

The present invention relates to a device for e.g. rehabilitation and assistance of hand motor functions, in particular to a portable and modular hand exoskeleton for use in activities of daily living.

### BACKGROUND ART

Medical rehabilitation of motor functions is usually performed in a hospital or the like in order to recover function lowered by disease or injury. Recently, for the purposes of improving recovery of impaired functions, enabling quantitative evaluations of recovery, reducing the burden of rehabilitation workers or the like, there have been made attempts to apply wearable exoskeletal technologies to rehabilitation and assistance of motor functions.

In particular, hand sensorimotor impairments are among the most common consequences of injuries affecting the central and peripheral nervous systems, leading to a drastic reduction in the quality of life for affected individuals. The use of wearable technologies has been proposed as a tool for restoring and complementing impaired motor functions for such users. By acting as complements of impaired human body's functions these systems can be used to provide motor assistance or to promote recovery of functions, both inside healthcare centers and during activities of daily living.

However, despite these systems are commonly used in research laboratories and highly-specialized centers, they still suffer from an important limitation: their adoption by users on a daily basis is limited because of complexity, poor usability and high costs. Indeed, the translation of these systems to domestic settings could enable intensive and continuous use during meaningful activities of daily living, ultimately improving their effectiveness.

Several concepts of hand exoskeletons for motor rehabilitation and assistance purposes have been proposed in the past. For instance, US Patent Application 2016/0361179 discloses a device for actively and dynamically assist and lock joints, with low power consumption, small volume and light weight, having a supporting structure in the joint, at least one tensioning system fixed to the supporting structure and at least one artificial tendon connected to the tensioning system. The tension system interacts with the locking system in order to assist the user's joints when needed.

US Patent Application 2016/0015590 discloses a hand exoskeleton device that can be mounted onto a human body, and can operate a three-layered sliding spring mechanism serving as a motion transfer mechanism for applying drive power to a distal interphalangeal joint (DIP joint), a proximal interphalangeal joint (PIP joint) and a metacarpophalangeal joint (MP joint) using a single direct acting actuator, thereby supporting the gripping motions of the human body with the device mounted thereon.

US Patent Application 2013/0219585 discloses a grasp assist system including a glove, actuator assembly, and controller. The glove includes a digit, i.e., a finger or thumb, and a force sensor. The sensor measures a grasping force applied to an object by an operator wearing the glove. Phalange rings are positioned with respect to the digit. A flexible tendon is connected at one end to one of the rings and is routed through the remaining rings. An exoskeleton positioned with respect to the digit includes hinged interconnecting members each connected to a corresponding ring, and/or a single piece of slotted material. The actuator assembly is connected to another end of the tendon. The controller calculates a tensile force in response to the measured grasping force, and commands the tensile force from the actuator assembly to thereby pull on the tendon. The exoskeleton offloads some of the tensile force from the operator's finger to the glove.

US Patent Application 2013/0072829 discloses a flexible, modular and lightweight hand rehabilitation device comprising a brace fitted to partially cover the patient's hand and forearm, the device comprising, all placed on the back of the hand with the palm totally free, flexible rods for a passive and assisted active bending/extension of the five fingers, finger gloves provided with thimbles, fixed rods or plates stabilised to thimbles and hinged to one end of the flexible rods by means of a hinge and a quick coupling mechanism defining an articulated joint, a movement/command and control unit integral to the brace or remotely located relative to the same and provided with five actuating means for moving the flexible rods and further comprising means for adjusting the tension of said rods, means for adjusting and adapting the rehabilitation device to the hand's anatomical features and a control and management software.

US Patent Application 2010/0041521 discloses a finger glove for use in gripping movements with one or more fingers of a human hand enclosed in the glove. The glove includes glove fingers and a palm. At least one glove finger is adapted to include on each side an artificial tendon that extends along an inside of the glove. A yoke is fitted in a tip of the at least one glove finger and intended to surround a tip of an enclosed finger. At each side of the glove finger artificial tendons are connected to the yoke. A system including the finger glove having a force detecting sensor is situated on the inside of the at least one glove finger and is adapted to detect a force between a finger enclosed in the glove finger and a contact surface applied to the finger. The artificial tendons for a glove finger are connected to at least one actuator and a control unit adapted to cause the at least one actuator to exert a pulling force on the artificial tendons of the glove finger based on a force detected in the force detecting sensor, whereby the finger enclosed in the glove finger is caused to bend.

All the above-mentioned hand exoskeletons present certain drawbacks or otherwise limitations, particularly when it comes to rehabilitation or use during activities of daily living. For instance, many of those devices are bulky, poorly usable and costly in view of their complexity. Some are not designed to be used outside of clinical settings and/or without any monitoring performed by a medical practitioner mainly because of their non-portability. Some devices do not allow to control both flexion and extension of fingers, and many of them do not preserve natural somatosensation on palms and fingertips.

Moreover, the vast majority of the prior art devices comprise some kind of orthosis, such as static orthosis or gloves. This aspect has the main advantage of facilitating the placement of sensors on or close to the fingertips; however, orthoses add weight on the hand and/or the arm of a user, thus hampering the residual motor capabilities of users, hinder easy wearing by users with hand contractures and many times, such as in the case of e.g. gloves, they keep the fingertips and/or the palm of the hand covered, hampering natural somatosensation in interactions with external objects and tools during use. Without being bonded to this theory, it is deemed that the motor recovery of the hand of an e.g. stroke survival is enhanced and even boosted when the natural somatosensorial perception is stimulated and facilitated during use, such as in the context of a rehabilitation protocol.

### SUMMARY OF INVENTION

The present invention provides for a new kind of hand exoskeleton for rehabilitative and assistive purposes that addresses the above-mentioned drawbacks of the devices known in the art.

A main of aim of the invention is to provide for a fully wearable, portable and minimally obtrusive exoskeleton device and to improve the known devices.

Another aim of the invention is to provide for a hand exoskeleton that may control flexion-extension of the fingers, while allowing natural somatosensorial interactions with the environment surrounding the users.

Still a further aim of the invention is to provide for a hand exoskeleton adapted to assist and restore hand functions of users with motor disabilities both during activities of daily living and in neurorehabilitative scenarios.

Still a further aim of the invention is to provide for a hand exoskeleton having a functional and lightweight design by exploiting the elements it is composed of both for motion transmission and as structural elements for the exchange of force with user's fingers.

Another aim of the present invention is to provide for a modular device, which modules may be adapted to meet users' specific needs.

Another aim of the invention is to provide for a hand exoskeleton simply wearable by impaired users, of a low-cost and of easy manufacturing. All these aims have been accomplished with the device of the invention, as described hereinafter and in the appended claims.

The device according to the present invention relies on modular exoskeletal fingers which employ actuating mechanisms and artificial tendons to control the fingers of the wearer. Among the main innovations of the hand exoskeleton of the present invention are its modular design and the lack of orthosis or the like, which allow to personalize it to the wearer's specific needs and to reduce the overall profile and bulkiness of the system. This has been mainly achieved through the design of the artificial tendons, according to an embodiment of this invention. Each of such tendons embeds means for transmitting motion from a driving mechanism to the fingers of a wearer, and may therefore enable the control of fingers independently from external orthotic structures or from other modules of the exoskeleton. Importantly, the artificial tendons may be used to control fingers motions from the back side of the hand, freeing the wearer's palm and fingertips from hindrances in interaction with external objects and tools. Overall, this approach has the unique advantage of enabling, within a single wearable, portable and modular device, control of fingers flexion and extension while preserving natural somatosensation on palms and fingertips of the wearer.

In an embodiment, the actuation, control and energy storage units are placed inside a chest-pack. This allows users sitting on a wheelchair to comfortably rest their backs and shoulders against the backseats of their wheelchairs, enabling comfortable use of the system for prolonged periods.

Accordingly, in an embodiment, the invention provides a modular, orthosis-free hand exoskeleton device, said device comprising at least one module, each of said modules comprising:
a bi-directional actuating mechanism;
a flexible cable having a proximal end, a distal end and an elongated shaft therebetween, said proximal end being operably connectable to the bi-directional actuating mechanism, and said distal end comprising means for fixation to a finger of a user;
a flexible sheath encasing the cable; and
means for fixation proximate to the metacarpophalangeal (MCP) joint of a user

wherein said distal end:
1) spans from the MCP joint fixation means up to the distal tip of the cable and
2) comprises a stretchable, elastic element along its length.

In embodiments, the device may comprise from one to ten modules as defined herein.

In embodiments, the stretchable, elastic element may be a tubular element coaxially located with respect to the flexible cable.

In embodiments, the bi-directional actuating mechanism may be a linear motor or pneumatic actuator included into a wearable and portable case. Preferably the case is wearable and portable.

In embodiments, the bidirectional actuating mechanism may be a servomotor.

In embodiments, the bi-directional actuating mechanism may be a mechanical element as a cable, pulley, spool etc. operated by the user.

In embodiments, the cable may have a length adapted to remotely locate the (for example wearable and/or portable) case, such as on the trunk of a user.

In embodiments, the cable and the sheath may be a Bowden cable

In embodiments, the device, when used as a hand exoskeleton, is preferably devoid of any element covering the fingertips and the hand's palm of a user/wearer, such as thimbles, gloves or sensors.

In embodiments, the means for fixation to a finger of a user may comprise means for fixation to the distal interphalangeal (DIP) joint of a user and/or means for fixation between the MCP and the proximal interphalangeal (PIP) joints and/or between the PIP and DIP joints of a user.

In embodiments, the stretchable, elastic element may comprise at least one reinforcing structure.

In embodiments, the at least one reinforcing structure may not be located in correspondence of the DIP and/or PIP joint(s).

In embodiments, the at least one reinforcing structure may comprise a thicker portion of the stretchable, elastic element.

The above and other objects, features and advantages of the herein presented subject-matter will become more apparent from a study of the following description with reference to the attached figures showing some preferred aspects of said subject-matter. However, the present invention is not limited to the embodiments as described in the following and/or depicted in the drawings which are provided as examples of possible embodiments; to the contrary, the scope of the present invention is defined by the appended claims.

### BRIEF DESCRIPTION OF DRAWINGS

In the Figures:

FIG. 1A depicts an isometric view of one embodiment of a device according to the invention embodied as a single module hand exoskeleton; FIG. 1B is a close up of the distal end of the same device;

FIGS. 2A and 2B schematically show the mechanism of action of a single module hand exoskeleton, in particular in an elongation operation, having coupled a single (2A) or double (2B) artificial tendon;

FIG. 3 shows a single module hand exoskeleton worn by a user; a wearable and portable motor actuator is located on the trunk of the user;

FIG. 4 shows a five-fingers hand exoskeleton worn by a user; a wearable and portable case comprising four motor actuators is located on the trunk of the user;

FIG. 5 shows a single module hand exoskeleton worn by a user upon actuation of the motor actuator bringing to finger flexion;

FIG. 6 shows a real-life, implemented embodiment of a five-fingers hand exoskeleton having a wearable and portable case comprising four motor actuators;

FIGS. 7A and 7B show an embodiment of a passive, user-operated actuating mechanism having an anti-phasic (7A) or phasic (7B) motion;

FIG. 8 shows an embodiment of a device according to the invention comprising reinforcing structures.

### DETAILED DESCRIPTION OF THE INVENTION

The present disclosure may be more readily understood by reference to the following detailed description presented in connection with the accompanying figures, which form a part of this disclosure. It is to be understood that this disclosure is not limited to the specific conditions or parameters described and/or shown herein, and that the terminology used herein is for the purpose of describing particular embodiments by way of example only and is not intended to be limiting of the claimed disclosure.

As used herein and in the appended claims, the singular forms “a”, “an” and “the” include plural referents unless the context clearly dictates otherwise. Also, the use of “or” means “and/or” unless stated otherwise. Similarly, “comprise”, “comprises”, “comprising”, “include”, “includes” and “including” are interchangeable and not intended to be limiting.

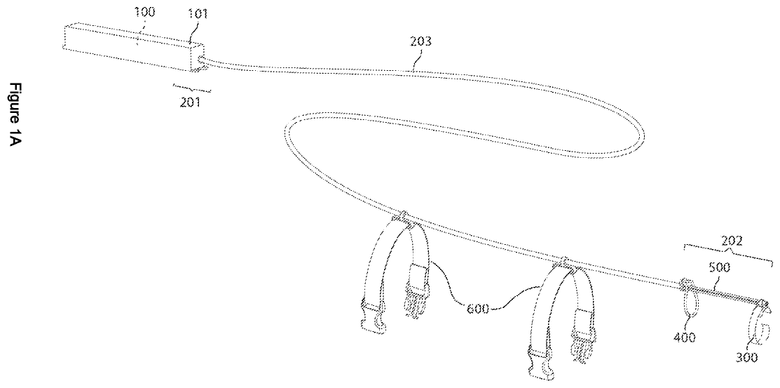

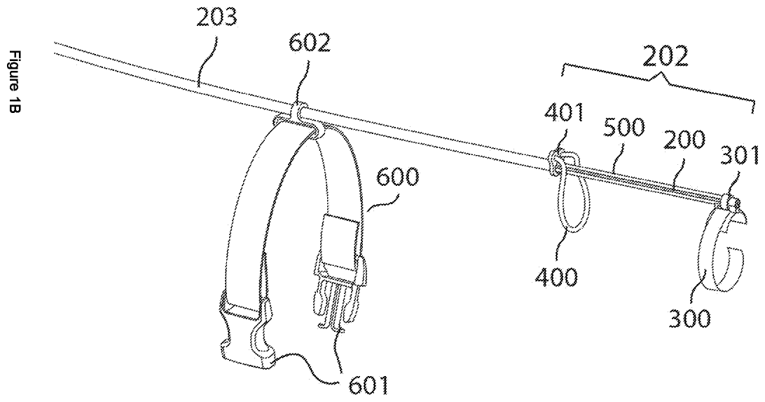

With reference to FIGS. 1A and 1B, one non-limiting embodiment of the device 1 of the invention is shown. As depicted therein, the device is embodied as a single module hand exoskeleton adapted to operate on a single finger of a user. Said single module hand exoskeleton comprises a bi-directional actuator 100 included into a case 101 designed to be a portable, wearable and light in weight so to be easily worn by a user in rehabilitation protocols and during activities of daily living. Said actuator 100 is operatively connected with a flexible, elongated cable 200, which is encased into a sheath 203 via the proximal end 201 of this latter.

For the sake of clarity, in the frame of the present disclosure, the expression “operatively connected” as well as “operatively connectable” reflects a functional relationship between the several components of the device of the invention between them, that is, the term means that the components are correlated in a way as to perform a designated function. The “designated function” can change depending on the different components involved in the connection; for instance, the designated function of a bi-directional actuator 100 is to longitudinally displace the cable 200 in order to elongate or retract it. A person skilled in the art would easily understand and figure out what are the designated functions of each and every component of the system of the invention, as well as their correlations, on the basis of the present disclosure.

The term “flexible”, as used herein, designates the capacity of a component of the present device to actively or passively bend in one or more off-axis directions according to the actuator-driven operation and/or to the movement of a user. In some embodiments, cable 200 and/or sheath 203, are non-stretchable in nature, i.e. they cannot be plastically or elastically elongated so to augment their length upon traction. In some alternative embodiments, cable 200 and/or sheath 203 can be stretchable, either intrinsically (i.e. due to the material(s) they are made of) or due to design properties (for example, they can comprise or consist of a coiled member). Typical shafts and cables suitable for this purpose are substantially composed of material with a semi-rigid nature or segmented mechanical structure, or any suitable combination of materials, such as metals or polymeric plastics such as Polyvinyl chloride (PVC), Polyamides (PA) Polyethylene (PE), Polypropylene (PP) and the like. Sheath 203 is typically made of flexible polymers and functions as a physical support for the cable 200, which is located into a hollow channel of said sheath 203 in a way as it may slide therein. Sheath 203 allows to conform the cable 200 to the shape of the user's arm and to fix the cable 200 to it, while allowing the cable 200 to slide inside, for the sake of actuating the finger(s) without or with limited buckling, as will be detailed later on.

In one embodiment, the sheath and shaft are constituted by a Bowden cable, a type of flexible cable used to transmit mechanical force or energy by the movement of an inner cable relative to a hollow outer cable housing. A Bowden cable typically comprises a protective plastic coating or sheath 203, a steel structure, an optional inner sleeve to reduce friction and an inner cable. Bowden cables are widely accessible and at a low cost, thus reducing the manufacturing-associated price. Of course, other equivalent systems may be used within the scope of the present invention.

At the distal end 202 of the cable 200, the device comprises means 300 for fixation to the finger of a user. Preferably, said means for fixation 300 are embodied as a hooks-and-loops rings easily adaptable on the distal interphalangeal (DIP) joint so to adjust the diameter thereof, or alternatively as a soft elastic threads or bands which loop around said anchor point. Advantageously, ring 300 is located at the distal tip of the cable 200 and joined to said cable 200 via an adjustable connection element 301. One main advantage of said configuration relies in the freedom of the fingertips of a user from any external structure such as gloves, thimbles or haptic/position sensors, so to keep unaltered the somatosensorial perceptions of the user. As it will be evident, the artificial tendons are conveniently worn by users on the back of their hands, so to leave both the palm and the fingertips unfettered.

The distal end 202 of the cable 200 further comprises means 400 for fixation proximate to the metacarpophalangeal (MCP) joint of a user; even in this case, e.g. hooks-and-loops rings or soft elastic threads and bands are coupled to the sheath 203 encasing the cable 200 via an adjustable connection element 401. In an embodiment, fixation means 300 span as well sections of the finger's phalanxes comprised between the MCP and proximal interphalangeal (PIP) joints, and/or between the PIP and DIP joints. The sheath 203 may be held on the arm and/or wrist of a user by means of adjustable fabric bands 600 or the like having side-release buckles 601 or the like operatively coupled by means of sheath-guides 602.

One of the key features of the device of the invention relies in the design of the artificial tendon. This component comprises two main parts, the cable 200 encased by a sheath 203 and the distal end portion 202. The distal portion 202 is characterized in that it spans in length from the MCP joint of a user, and in particular from the fixation means 400 up to the tip of the cable 200 where means 300 for fixation to the DIP joint or other anchor points on the finger are located, and in that it further comprises a stretchable, elastic element 500 encasing it, and in some embodiments its entire length. Due to the different propensity to be stretched of its constituting parts, the tendon serves a dual purpose. In correspondence of the sheath 203, the tendon acts as a flexible transmission mechanism which route the motion imposed on the cable 200 by the actuating mechanism up to the distal end 202. Conversely, the stretchable element 500 enables a higher flexibility of the distal end portion 202, allowing the exchange of the force from the actuated cable 200 to an actuated mechanism e.g. a finger. This stretchable element 500 in particular represents one of the concepts behind the invention, which may enable the functional bending of the fingers' joints of a user wearing the exoskeleton by exploiting a very simple but efficient physical effect to avoid a typical drawback encountered when working with cables.

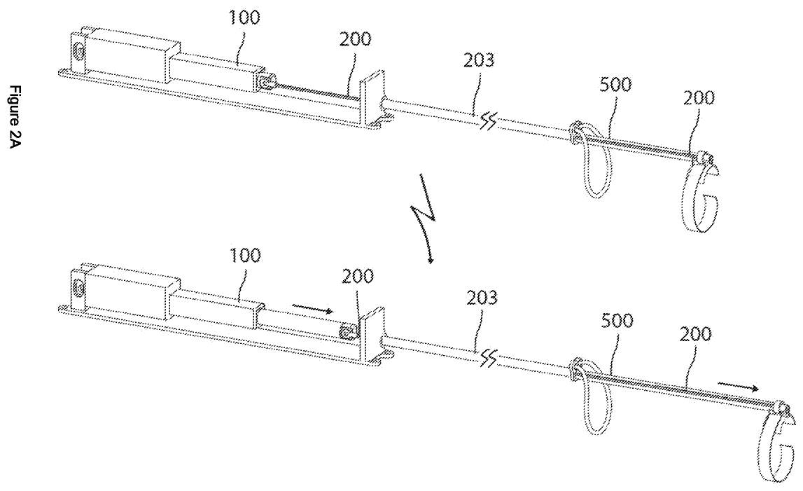

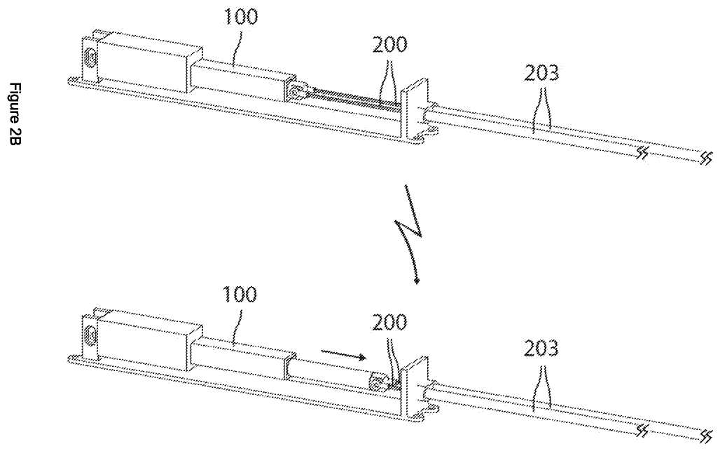

In fact, what usually happens when an uncompressible, flexible body as a flexible cable 200 is fixed at one of its extremities (i.e. ring 300) and exposed to a compression from the other extremity (i.e. the proximal end 201)—which is one of the actuation operations of the device of the invention-, is that the body of the cable 200 buckles, forming a so called three bend saddle, thus dissipating the compressive force off the shaft's longitudinal axis. To counteract this detrimental effect, the present inventors opted for including at the distal end 202 of the tendon a stretchable, elastic element 500 operatively coupled to said distal end 202. In an embodiment, the element 500 is a tubular component wrapped around the a section of the cable 200, fixed on one extremity to sheath 203 at the level of fixation means 400 and on the other extremity to the tip of the cable 200, and is substantially made of an elastomeric material such as silicon polymers (e.g. PDMS) having tensile strength comprised between 0.1 and 100 M Pa (see for instance FIG. 2).

Importantly, the flexible element 500 is built-in, joined together to the sheath 203. Therefore, the ensemble of sheath 200, sheath 203 and elastic element 500 represents an independent module, the artificial tendon, which may enable, when fixed to a user's finger, the control of said finger. This allows to implement a modular design, where each exoskeletal finger is independent from all the others and does not depend on the presence of additional elements (such as e.g. orthoses or the like). In this way, user's specific functional needs may be targeted, for the sake of eliminating not-needed functions and reducing complexity (such as exoskeletal fingers not required by the user), and thus reducing the overall profile and encumbrance of the system.

As it will be therefore evident, the distal end 202 is characterized in that it does not have a predefined structure which defines nor its degrees of freedom neither its range of motion. Because of the flexibility of the cable 200 and of the elastic element 500, the distal end 202 has virtually infinite degrees of freedom in the three-dimensional space. Advantageously, when the cable 200 is pushed inside the elastic element 500 upon the actuator's 100 driven operation, the element 500 conformably adapts to the increased length of cable 200 inside it by elongating, hampering offset forces by laterally constricting the distal end 202, so to longitudinally guide the cable 200 (see FIG. 2). Upon retraction of the cable 200, element 500 elastically recovers to its original shape and length.

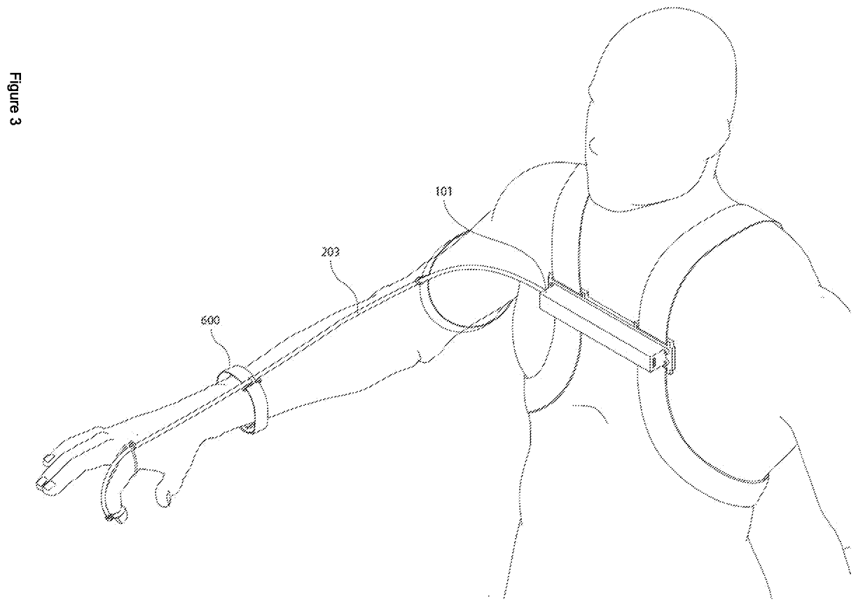

Nonetheless, when the distal end 202 is constrained onto a driven mechanism, such as e.g. a user's finger, its degrees of freedom are imposed by the morphology of said finger. In this case, upon a compression of the cable 200 the elastic element 500 will not be able to elongate across its longitudinal axis because of the impossibility to elongate the human finger it is constrained to. Hence, the elongation of the elastic element 500 will provoke an overall flexion of the finger of the wearer due to the unconstrained hinges offered by the MCP and PIP joints on the wearer's hand (FIGS. 3 to 5).

Conversely, a decrease of the length of the cable 200 inside the distal element 202, due to a traction imposed by the actuator 100, will result in a shortening of the elastic element 500 and in a consequent finger extension, due to the same principles described before, mutatis mutandis.

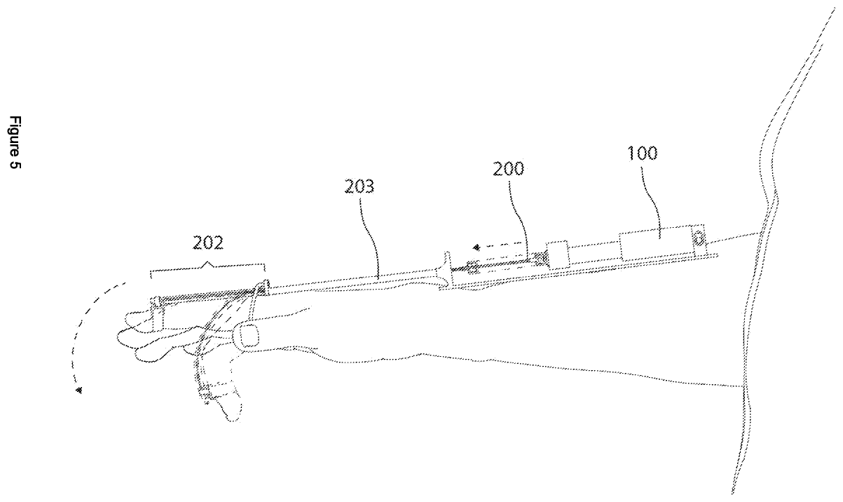

The presence of the elastic element 500 is hence important in the compression phase of the cable in that it avoids the cable 200 to buckle above the finger of the wearer, into holding the cable 200 as close as possible to the finger and therefore maximizing the translation of the linear elongation of the elastic element 500 into circular arcs centred around are the MCP and PIP joints (see FIG. 5).

Each tendon employs a bi-directional driving mechanism to actuate its shaft and, by exploiting the fingers-shaft coupling through the tubular elements and the constraints imposed by the morphology of the skeletons of the fingers, to consequently control fingers flexion and extension. The under-actuation at the single-finger level exploits the physiological coupling between same-finger phalanges in order to allow the objects under manipulation to shape the hand of the user. This induces natural and comfortable grasps without the independent actuation of each phalanx or the intervention of complex closed-loop algorithms.

Additionally, the functional coupling of the elastic element 500 with a user's finger is exploited for the sake of partially constraining the under-defined kinematical structure of the distal element 202, thus allowing intrinsically optimal compliance of the exoskeletal finger with respect to any hand morphology, without the need of user-specific customization or parametric designs.

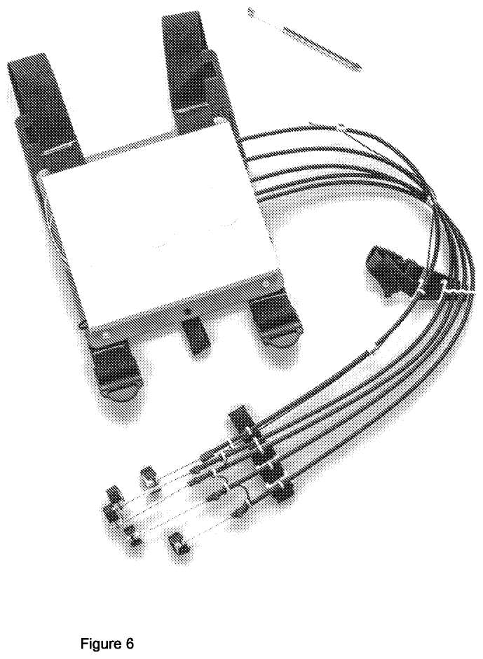

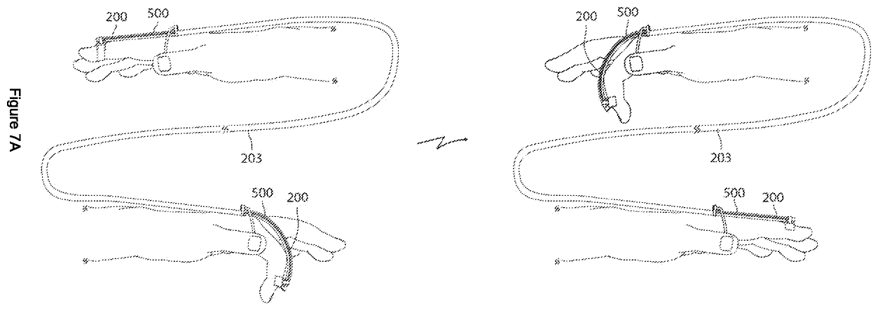

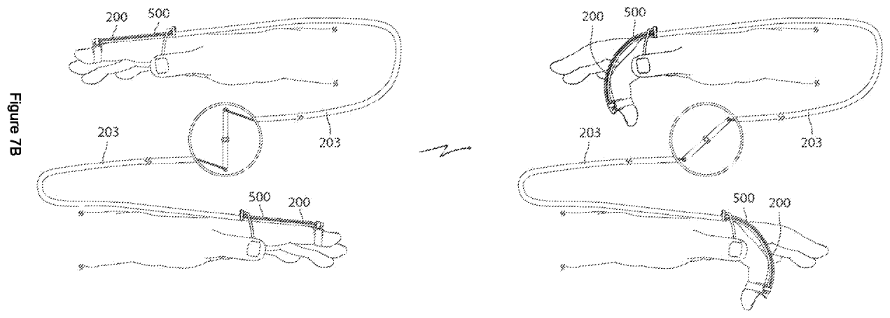

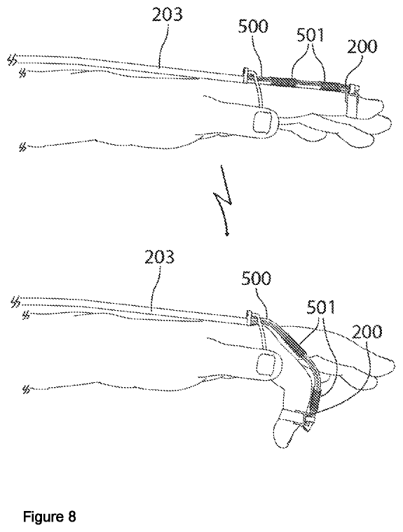

In some embodiments, the stretchable, elastic element 500 can comprise at least one reinforcing structure (501; FIG. 8). In these embodiments, some rigid plastics, textiles or any other suitable material/component having a higher elastic modulus with respect to the elastic element 500 can be added or embedded during the manufacturing process or thereafter into or onto said elastic element 500. Most preferably, said at least one reinforcing structure 501 is not located in correspondence of the distal interphalangeal (DIP) and/or proximal interphalangeal (PIP) joint(s). The aim of a reinforcing structure 501 is to twofold: on one hand, it allows the elastic element 500 to better conform to the anatomy of a user's finger, and at the same time it facilitates and focuses the discharge or the elongation pressure only where it is needed, i.e. in correspondence of the fingers' joints. In an alternative or additional scenario, said at least one reinforcing structure 501 can be embodied as a thicker portion of the stretchable, elastic element 500, depending on the needs and circumstances. Changing the shape and/or the dimensions (e.g., the thickness) of the elastic element 500 in certain locations would locally alter its mechanical properties such that some portions of the elastic element 500 would act as a reinforcing structure.

Turning back to the actuation mechanism, this may be a conventional actuator 100 that implements the linear motion to push and pull the sheath 200 along its longitudinal axis. As a way of non-limiting example, the actuator 100 may be embodied as a pneumatic or hydraulic piston engine comprising a piston contained by a cylinder; alternatively, the actuator 100 may be embodied as a commercially available rotational actuator having a moving organ operatively connected with the cable 200; still alternatively, the actuator 100 may be a rotational actuator coupled to a spool to turn in a way to wind up/unwind the cable 200. In one embodiment, actuator 100 may be a linear servomotor, using a closed-loop, error-sensing for position feedback to control/correct its motion and final position of the cable 200. The entire actuating mechanism may be power-supplied by an external energy source or embedded batteries, and may further comprise means for wired or wireless connection of the entire system to external devices such as computers, tablets, smartphones, microcontrollers, systems for electromyography and the like.

In an additional or alternative embodiment, the bi-directional actuating mechanism 100 is a mechanical element operated by the user, i.e. in which the operator acts as the motor. In this embodiment, the actuating mechanism is referred to as a “passive” actuator, i.e. in which no motors are included, thus rendering the entire system free of any external or embedded energy source and extremely light in weight. As a way of example, one embodiment of this passive actuating mechanism is shown in FIGS. 7A and B. As depicted, the artificial tendon may span in length from one finger of the right hand of the user up another finger of the left hand. By moving one finger, the opposite finger will be easily and automatically moved. In one embodiment, an anti-phasic motion is used (FIG. 7A), in which the actuating finger is in anti-phase with the actuated finger (a flexion of the actuating finger induces an extension of the actuated finger, and vice-versa). Alternatively, a phasic motion, exploiting a coupling element, allows a flexion of the actuating finger to induce a flexion of the actuated finger, and vice-versa, having the further advantage of coherent motions between the actuating and the actuated fingers.

Possibly, one actuating finger may be used to actuate more than one finger or vice-versa. The mechanisms implemented for coupling the fingers can be miniaturized and made portable, and located remotely from the user or worn.

As depicted in FIG. 3 showing a single-module hand exoskeleton device worn by a user, the cable 200 has a length adapted to remotely locate the wearable, portable 101 case on the trunk of said user. The case 101 may comprise adjustable belts in order to easily wear it as a chest- or back-pack.

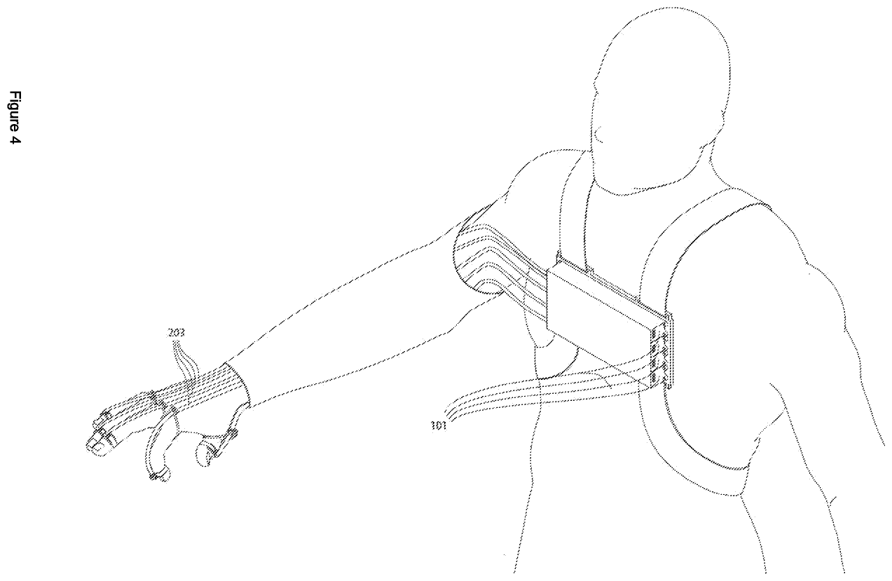

The device may comprise one to ten modules depending on the needs and circumstances; for instance, a five-module device is typically used in scenarios where each of the five fingers of a hand shall be independently mobilized, similarly a device with more than five modules may also be envisaged when both hands should be involved. In some embodiments, depending on the needs and circumstances, the actuation of some fingers might be coupled, e.g. the ring and pinky fingers, allowing to reduce the overall bulk of the device while maintaining functionality. FIG. 4 shows an example of a four-module device in which three fingers are independently actuated by means of three independent modules, whereas two fingers are jointly actuated by means of a single module. This is only an example and in some embodiments, less than three fingers or more than three fingers may be actuated independently.

As it will be evident from the present disclosure and the accompanying Figures, the device of the invention is completely free from any hand orthosis. As used herein, the term “orthosis” refers to static orthoses, i.e. orthoses designed to prevent or limit moveable parts. These include immobilizing orthoses, preventing any movement in the joints involved, and restrictive orthoses, which limit the movement in a specific aspect of joint range of motion. Typical static orthoses are splints, casts or braces.

Notwithstanding the usefulness of the device of the invention in hand rehabilitative and assistive contexts, it may be as well used in different settings such as virtual or augmented reality, for gaming, telemanipulation or in mixed situations in which e.g. virtual reality is exploited for rehabilitation purposes.

An embodiment of the device is shown in FIG. 6. It comprises two main components, a chest-pack and actuated exoskeletal tendons. The chest-pack, wearable by means of adjustable belts, hosts the actuation, control and energy storage units. Its size is: 200×210×33 [width×length×height] mm. The artificial tendons comprise Bowden cables (1.6 mm, Shimano, Japan), actuated by linear servomotors (L16 R, Actuonix Motion Devices Inc., Canada). Bowden cable sheaths (5 mm, Shimano, Japan) route the tendons from the actuators to the metacarpophalangeal (MCP) joints on the hand. The ends of the sheaths are fixed on the MCPs by means of soft elastic threads which loop around the fingers of the wearer. From the MCPs, the artificial tendons are routed and held in place on the fingers by means of hooks-and-loops rings and silicon tubular elements. The thumb, index and medium fingers are independently actuated by means of three independent modules, whereas the ring and little fingers are jointly actuated by means of a single module. This is only an example and other configurations of independently actuated fingers and/or jointly actuated fingers may be envisaged, on the same hand and/or on both hands of the wearer, this principle being applicable to all body members to which the principle and device of the present invention is applied.

The ends of the tendons are fixed using hooks-and-loop rings on the distal interphalangeal (DIP) joints, in order to keep the fingertips free from any external structure. Furthermore, no soft or hard structures are placed on the palm of the user. The sheaths are held on the arm and/or wrist of the wearer by means of adjustable fabric bands and custom 3D printed sheath-guides. The fabric bands are worn and unworn by means of commercial side-release buckles.

In an embodiment, the control unit comprises a microcontroller (Arduino Mega 2560 R3, Arduino, Italy), which runs the firmware of the system, plus a custom PCB board hosting a Bluetooth radio (HC-06, Guangzhou HC, China) for wireless communication with external devices such as PC or smartphones. The linear actuators provide a standard 3-wired interface for radio-controlled servomotors, allowing the implementation of closed-loop position-control through the sending of pulse-width modulated (PWM) references by the microcontroller. The system is powered by a LiPo battery (H2B180, Hy-Line, Switzerland) that provides an autonomy of up to 3 hours in continuous operation mode. The chest-pack cover and the sheath-guides were manufactured by means of 3D printing (HP Color DesignJet 3D, Stratasys, US). The exoskeleton may be pulled on or off in around five minutes. The overall weight on the arm of the wearer is below 50 g, whereas the weight of the chest-pack is around 930 g.

Compared to prior devices, the presented approach has the unique advantage of enabling, within a single wearable, portable and modular device, control of fingers flexion and extension while preserving natural somatosensation on palms and fingertips of the wearer.

Exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is not defined solely by the claims. The features illustrated or described in connection with an exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein, the scope of the present invention is not so limited.

Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A modular, orthosis-free hand exoskeleton device, said device comprising at least one module, each of said modules comprising:
a bi-directional actuating mechanism;
a flexible cable having a proximal end, a distal end and an elongated shaft therebetween, said proximal end being operatively connectable to the bi-directional actuating mechanism, and said distal end comprising means for fixation to a finger of a user;
a flexible sheath encasing the cable; and
means for fixation proximate to the metacarpophalangeal (MCP) joint of a user
wherein said distal end:
(1) spans from the MCP joint fixation means up to the distal tip of the cable and
(2) comprises a stretchable, elastic element along its length.

2. The hand exoskeleton device of claim 1, wherein the stretchable, elastic element is a tubular element coaxially located with respect to the flexible cable.

3. The hand exoskeleton device of claim 1, wherein the bi-directional actuating mechanism is a linear motor or pneumatic actuator included into a case.

4. The hand exoskeleton device of claim 3, wherein the case is wearable and/or portable.

5. The hand exoskeleton device of claim 3, wherein the bidirectional actuating mechanism is a servomotor.

6. The hand exoskeleton device of claim 1, wherein the bi-directional actuating mechanism is a mechanical element as a cable, pulley, spool etc. operated by the user.

7. The hand exoskeleton device of claim 1, wherein the cable has a length adapted to remotely locate the wearable and portable case, such as on the trunk of a user.

8. The hand exoskeleton device of claim 1, wherein the cable and the sheath is a Bowden cable.

9. The hand exoskeleton device of claim 1, wherein it is devoid of any element covering the fingertips and the hand's palm of a user, such as thimbles, gloves or sensors.

10. The hand exoskeleton device of claim 1, wherein said means for fixation to a finger of a user comprises means for fixation to the distal interphalangeal (DIP) joint of a user and/or means for fixation between the MCP and the proximal interphalangeal (PIP) joints and/or between the PIP and the DIP joints of a user.

11. The hand exoskeleton device of claim 1, wherein the stretchable, elastic element comprises at least one reinforcing structure.

12. The hand exoskeleton device of claim 11, wherein said at least one reinforcing structure is not located in correspondence of the DIP and/or PIP joint(s).

13. The hand exoskeleton device of claim 11, wherein said at least one reinforcing structure comprises a thicker portion of the stretchable, elastic element.
